(19) United States
(12) Patent Application Publication
(10) Pub. No.: US 2024/0032531 A1
(43) Pub. Date: Feb. 1, 2024

(54) METHOD AND APPARATUS FOR PRESERVATION OF BIOLOGICAL MATERIAL

(71) Applicant: VITRAFY LIFE SCIENCES LIMITED, Hobart (AU)

(72) Inventors: Brian Taylor, Hobart (AU); Sean Cameron, Hobart (AU); Brent Owens, Hobart (AU)

(21) Appl. No.: 18/268,097

(22) PCT Filed: Dec. 17, 2021
(86) PCT No.: PCT/AU2021/051517

§ 371 Date: Jun. 16, 2023

(30) Foreign Application Priority Data
Dec. 18, 2020 (AU) 2020904746

(51) Int. Cl. A01N 1/02; B01L 7/00

(52) U.S. Cl. CPC A01N 1/0257; A01N 1/0284; B01L 7/50; B01L 2400/0487; B01L 2300/185

(57) ABSTRACT

An apparatus for preserving biological material, comprising an insert configured to be arranged within an outer insulated tank, the insert defining a compartment for receiving biological material, such that, in operation, biological material in the compartment is immersed in the heat exchange fluid to exchange heat with the heat exchange fluid for freezing of said biological material, the apparatus further comprising a pump that is operable to adjust a flow of heat exchange fluid over the biological material in the compartment, the pump being operable to cool the biological material at one or more different stages of cooling.

### FIELD OF THE INVENTION

The present invention relates to methods of preserving biological material and apparatuses for preserving biological material.

### BACKGROUND

Sperm cryopreservation (freezing) has been used successfully in conjunction with infertility treatment for over 40 years resulting in thousands of births. In cases of very poor semen quality, utilization of frozen donated sperm can provide a mechanism by which to conceive. Freezing of donor sperm has the added benefit of facilitating repeated use by patients to achieve a family with the same biological father and also maximises the efficiency of utilisation of the material available to the population of patients requiring this often limited resource. Sperm freezing prior to commencing cancer treatment in males can also, in many cases, provide the only available option to preserve their fertility.

Freezing of sperm was first reported in 1953 using the cryoprotectant glycerol. This procedure continues to be used today with only minor modifications. Three methods of freezing are in routine use: a) suspension of vials or straws in liquid nitrogen vapor [2] b) cooling at an estimated rate of freezing of 10° C./min or c) use of a control rate freezing machine freezing at 1.5° C./min. There is obviously large variation across these methods and few optimisation studies have been performed. During freezing and subsequent thawing damage can result from osmotic and oxidative stress, toxicity from the cryoprotectant and the formation of intracellular ice crystals, reducing the number of normally functional sperm post thawing. Therefore, the efficiency of cryopreservation is critical to minimize the risks of damage to sperm. To reduce the impact of osmotic changes and oxidative stress proteins and antioxidants have been added prior to, and during, freezing to reduce damage. However, these approaches are often merely a way to compensate for inadequate freezing and thawing protocols.

In many situations in assisted reproductive treatment (ART), such as embryo cryopreservation, only a very small number of cells are frozen and high cell survival rates are crucial to successful outcomes. In contrast, the large number of sperm normally available for freezing means that lower survival can often be tolerated without major clinical impact. Consequently, there has been minimal research into improving freezing outcomes for sperm. This can, however, have significant implications in situations where initial numbers and quality of sperm are dramatically reduced as in the case of many infertile males undergoing testicular biopsy to recover sperm. Sperm samples with intrinsically reduced motility result in lower fertilization when frozen compared to fresh and a similar phenomenon has also been described for sperm with normal pre-freeze characteristics leading to a reluctance to use frozen sperm for intrauterine insemination. Our own data from over a thousand young women undergoing intrauterine insemination (IUI) agree with the concept of reduced potential of frozen sperm which achieves only half the pregnancy rate (16%) of that associated with natural fertility. These type of figures often influence clinical decisions to use the significantly more invasive and expensive IVF technique as a first line treatment instead of attempting IUI.

Long term cancer survival rates have significantly increased over the last decades due to improvements in cytotoxic therapies. Over 80% of children and adolescents survive cancer, so that 1 in 900 adults aged 16-45 years is a survivor. Therefore, improving quality of life for this growing population of survivors, with all of the normal life expectations including reproduction, is a major health priority. However, a consequence of cytotoxic cancer treatments is the destruction of ovarian follicles resulting in premature menopause, so that the fertile window is either short lived or eradicated in women. By the age of 30 years between 40 and 97% of female survivors may experience infertility depending on type and dose of treatment, and age at treatment. This is generally reflected in the ovarian follicle population.

The distress to patients caused by the possible loss of fertility, and the significant level of regret when measures to protect fertility are not offered prior to treatment has been well documented. Discussing the impact of cancer treatment on fertility and potential ways to preserve fertility is now an international standard of care. Fertility preservation via cryopreservation of oocytes (mature eggs) or ovarian tissue containing immature primordial follicles (harvested via laparoscopy and frozen for grafting back into the body at a later date) are now well established procedures in children and women to provide them with options to reproduce with their own genetic material after cancer survival. If the subsequent graft is successful, it may restore endocrine function and produce mature oocytes for years. The birth of twins following oocyte collection from cryopreserved ovarian tissue transplanted at a non-ovarian site, by our group, shows unequivocal evidence of successful preservation of primordial follicles. Only 140 births have been reported worldwide from cryopreserved ovarian tissue transplanted back to the women from where it originated.

The ability to store red blood cells (RBCs) outside of the body has been regarded as a life-saving practice for many years. More recently, the usage of refrigerated stored RBCs in transfusion medicine has been under extensive evaluation. During refrigerated storage RBCs progressively deteriorate and infusion of prolonged stored RBCs has been linked to adverse clinical outcome in terms of postoperative infections, length of hospital stay and mortality.

Concerns regarding the infusion of stored RBCs still remains and a restrictive transfusion strategy is currently being favoured. This has resulted in a revived interest in cryopreservation. Storage of RBCs at ultra-low temperatures halts the cellular metabolism and subsequently prevents the progressive cellular deterioration that has been linked to adverse clinical outcome.

Initially, cryopreservation appeared a promising approach for maintaining RBCs viable for prolonged periods of time. However, the clinical applicability of cryopreserved RBCs (commonly known as “frozen RBCs”) was hampered by the expensive, time-consuming and inefficient nature of this preservation method.

### Requirements of Refrigerated Stored RBCs

Currently RBCs are routinely stored at 2-6° C. for a maximum of 5 to 6 weeks, depending on the retention of viable RBCs. Cryopreservation, on the other hand, enables storage of RBCs for years. Cryopreservation is currently a valuable approach for long-term storage of RBCs from donors with rare blood groups and for military deployment. However, stockpiling cryopreserved RBCs can also be beneficial in emergency or clinical situations, where the demand exceeds the supply of RBCs. The shelf life of cryopreserved RBCs using current methods is up to ten years.

International guidelines require that haemolysis in a refrigerated RBC storage unit must remain below allowable levels (i.e., 0.8% in Europe and 1% in The United States) and that at least 75% of the infused RBCs must still circulate 24 hours after infusion.

However, the guidelines do not specifically reflect the RBCs' ability to function after infusion.

### Quality of Stored RBCs

Although storage at 4° C. slows down the biochemical processes in the RBCs, cellular metabolism is not completely suppressed at these temperatures. During refrigerated storage a variety of changes have been observed that could compromise the RBCs' ability to function after infusion. These changes include decreased concentrations of 2,3-diphosphoglycerate (DPG), adenosine triphosphate (ATP) and membrane sialic acid content. Other changes include translocation of phosphatidylserine (PS) to the cell surface, oxidative injury to membrane lipids and proteins, shape change to spheroechinocytes, membrane blebbing and accumulation of potassium, free haemoglobin (Hb), cytokines, bioactive lipids and (pro-coagulant) microvesicles in the RBC storage unit.

The RBCs' rheologic properties also become impaired during refrigerated storage. Refrigerated RBCs demonstrate an increased tendency to aggregate and adhesion to endothelial cells (ECs), as well as reduced deformability from the second week of storage. These changes may hamper the RBCs' ability to function properly in the microcirculation.

Storage of RBCs at ultra-low temperatures ceases the biological activity of RBCs, enabling them to be preserved for prolonged periods of time. In general, either high concentrations of cryoprotective additives or rapid freezing rates are necessary to prevent cell damage. At slow cooling rates, extra-cellular ice formation will occur. As ice forms, the solute content of the unfrozen fraction becomes more concentrated. The resulting osmotic imbalance causes fluid to move out of the RBC and intracellular dehydration occurs. On the other hand, at rapid cooling rates the RBC cytoplasm becomes super-cooled and intracellular ice formation occurs, which subsequently can lead to mechanical damage.

In order to minimise freezing damage, it has been thought that cryoprotective additives are crucial. Over the years, different non-permeating and permeating additives for the cryopreservation of RBCs have been investigated. Non-permeating additives such as hydroxyethyl starch and polyvinylpyrrolidone, as well as a variety of glycols and sugars appeared promising because it was proposed that removal from thawed RBCs prior to transfusion was not required.

Conversely, the permeating additive glycerol is known for its ability to protect RBCs at ultra-low temperatures. The concentration of glycerol that is necessary to protect the RBCs is dependent on the cooling rate and the storage temperature. Glycerol protects the RBCs by slowing the rate and extent of ice formation while minimising cellular dehydration and solute effects during freezing.

### Requirements of Cryopreserved RBCs

Although preservation of RBCs at ultra-low subzero temperatures enables them to be preserved for years, once thawed, the shelf life of RBCs is limited. Deglycerolised RBCs are primarily stored in saline-adenine-glucose-mannitol (SAGM) preservation solution for up to 48 hours or in AS-3 preservation solution for up to 14 days. Cryopreserved RBCs need to be deglycerolised to reduce the residual glycerol content to below 1%. Furthermore, the RBCs are subject to the abovementioned international guidelines requiring that haemolysis in the RBC units must remain below allowable levels (i.e. 0.8% in Europe and 1% in The United States) and that the RBC post-thaw recovery after deglycerolisation (i.e. freeze-thaw-wash recovery) must exceed 80%. Also, at least 75% of cryopreserved RBCs must still circulate 24 hours after infusion.

Freezing Methods with Glycerol

Currently there are two freezing methods accepted for the preservation of RBCs with glycerol.
1. RBCs can be frozen rapidly in liquid nitrogen using a low-glycerol method (LGM) with a final concentration of approximately 20% glycerol (wt/vol) at temperatures below −140° C.
2. RBCs can be frozen slowly using a high-glycerol method (HGM), allowing storage of RBC units with a final concentration of approximately 40% (wt/vol) glycerol at temperatures between −65° C. and −80° C.
3. RBCs can be rapidly frozen using standard formations of 10% dimethyl sulfoxide (DMSO).

Cryopreserved RBCs are less efficient due to the cellular losses that occur during the processing procedure. This cell loss is more pronounced in HGM cryopreserved RBCs (approximately 10-20%) since these RBCs require more extensive washing. However, despite the higher yield of RBCs with the LGM, it is generally considered that HGM cryopreserved RBCs can tolerate wide fluctuations in temperature during freezing and are more stable during post-thaw storage. In addition, HGM cryopreserved RBCs do not require liquid nitrogen which eased storage and transportation conditions. Consequently, the HGM is currently the most applicable RBC freezing method in Europe and the United States.

The storage method associated with the HGM of cryopreservation results in intracellular dehydration due to the high glycerol content and storage temperature ranges. Further, the HGM method is, in many applications, associated with increased cell death because of the slow transition of the preserved cells and surrounding materials from the fluid to the solid state, or vice versa, leading to osmotic shock damage.

In contrast, LGM minimizes solute concentration effects and thereby osmotic shock effects, but intracellular ice formation may become an issue if the rapid cooling rate does not allow sufficient time for water to migrate out of the cells.

Preferred embodiments of the present invention seek to utilise lower glycerol content, thereby minimising cellular dehydration and solute effects, while extending the shelf life of cryopreserved RBCs.

Other preferred embodiments seek to reduce or eliminate the use of cryoprotectants while maintaining cell viability.

### SUMMARY

While the above background relates to RBCs, it will be appreciated that embodiments of the present invention may be applied to other biological material such as stem cells (eg from bone marrow, umbilical cord blood, amniotic fluid, etc), other blood products (eg leucocytes, plasma, platelets, and serum), microorganisms such as bacteria and fungi, germ cells and associated materials such as seminal fluid, tumour cells, colostrum, vaccines, and plant cells.

As used herein, “biological material” includes the following non-exhaustive list of materials: blood, plasma, platelets, germs, bacteria, organs, seminal fluid, eggs, colostrum, skin, serum, vaccines, stem cells, umbilical cords, bone marrow, and the other materials listed above.

According to a first aspect of the present invention, there is provided an apparatus for preserving biological material, comprising an insert configured to be arranged within an outer insulated tank, the insert defining a compartment for receiving biological material, such that, in operation, biological material in the compartment is immersed in the heat exchange fluid to exchange heat with the heat exchange fluid for freezing of said biological material, the apparatus further comprising a pump that is operable to adjust a flow of heat exchange fluid over the biological material in the compartment, the pump being operable to cool the biological material at one or more different stages of cooling.

The one or more different stages may be based on a heat transfer response of the biological material. Preferably, the heat transfer response is based on thermodynamic modelling of the biological material.

The pump preferably has a pumping capacity of at least 50 L/min, preferably at least 60 L/min, preferably at least 70 L/min, and further preferably at least about 80 L/min. Additionally or alternatively, the pump preferably has a pumping capacity of up to about 100 L/min, preferably up to 120 L/min, preferably up to about 150 L/min.

The apparatus preferably further includes a tube arrangement for conveying the heat transfer fluid from the pump to the compartment, the tube arrangement including a substantially linear elongate tube portion (or a straight tube section) leading into the compartment, and having a length of at least about 0.2 m, preferably at least about 0.4 m, and further preferably at least about 0.5 m. The linear elongate tube is preferably arranged immediately before the compartment. The elongate tube portion preferably has a diameter of about 1 inch, about 0.5 inches, or up to about 1.5 inches.

In a preferred embodiment, inflow of a heat exchange fluid into the compartment from the outer insulated tank is at or adjacent one face of the insert, and outflow of the heat exchange fluid out of the compartment to the outer insulated tank is at or adjacent said face of the insert.

Another aspect of the present invention provides a method of preserving biological material, comprising:
a. estimating a sensitivity of the sample to osmotic shock based on one or more biological material characteristics, the one or more biological material characteristics including at least one of: cell structure, cell size, membrane sensitivity, density, and age of donor;
b. approximating the onset of liquid-solid phase transition for the sample based on the estimated sensitivity of the same to osmotic shock;
c. determining an average temperature reduction rate of the core of the sample at a predetermined sample surface temperature up to about the onset of phase transition and corresponding heat exchange fluid flow rate required to obtain a predetermined slow cooling rate;
d. determining an average temperature reduction rate of the core of the sample at a predetermined sample surface temperature from about the onset of phase transition and corresponding heat exchange fluid flow rate required to obtain a predetermined rapid cooling rate;
e. cooling the sample in said compartment of the apparatus previously described at said slow cooling rate up to about the onset of phase transition; and
f. cooling the sample in said compartment at the rapid cooling rate from about the onset of phase transition to a final target temperature.

The method preferably further comprises immediately storing the cooled sample from the compartment.

Preferably, according to the method, the sample does not contain cryoprotectant.

A further aspect of the present invention provides a method of determining an amount of cryoprotectant to be added to a biological material prior to preservation, comprising:
a. estimating a sensitivity of the sample to osmotic shock based on one or more biological material characteristics, the one or more biological material characteristics including at least one of: cell structure, cell size, membrane sensitivity, density, and age of donor;
b. approximating the onset of liquid-solid phase transition for the sample based on the estimated sensitivity of the sample to osmotic shock;
c. determining an average temperature reduction rate of the core of the sample at a predetermined sample surface temperature up to about the onset of phase transition and corresponding heat exchange fluid flow rate required to obtain a predetermined slow cooling rate;
d. determining an average temperature reduction rate of the core of the sample at a predetermined sample surface temperature from about the onset of phase transition and corresponding heat exchange fluid flow rate required to obtain a predetermined rapid cooling rate; and
e. if the heat exchange fluid flow rate calculated at step (c) corresponds to a pump duty or an evaporator duty of the apparatus that is above a predetermined pump duty or predetermined evaporator duty respectively, selecting an amount of cryoprotectant that is a predetermined amount more than the initial amount to define a new initial amount or, if the heat exchange fluid flow rate calculated at step (c) corresponds to a pump duty or an evaporator duty that is equal to or less than the predetermined pump duty or predetermined evaporator duty respectively, selecting the initial amount of cryoprotectant as said amount of cryoprotectant to be added to a biological material prior to preservation; and
f. if the heat exchange fluid flow rate calculated at step (c) corresponds to a pump duty or an evaporator duty that is above the predetermined pump duty or predetermined evaporator duty respectively, repeating steps (a) to (d) until the heat exchange fluid flow rate calculated at step (c) corresponds to a pump duty or an evaporator duty that is equal to or less than the predetermined pump duty or predetermined evaporator duty respectively.

Preferably, according to the method, the initial amount of cryoprotectant prior to any repetition of steps (a) to (d) is zero.

The slow cooling rate may be up to about 10° C. per minute. Preferably, the slow cooling rate is between about 0.1° C. and about 10° C. per minute.

The rapid cooling rate may be greater than about 100° C. per minute. The rapid cooling rate is preferably greater than about 200° C. per minute.

Preferably, the onset of liquid-solid phase transition is approximated from a cooling curve of the sample undergoing freezing at a consistent cooling rate. The cooling curve of the sample undergoing freezing may be obtained from said computational fluid dynamics analysis on the sample.

Another aspect of the present invention provides a method of thawing a frozen preserved biological material, comprising:
a. determining the total surface area of an approximated geometry of the biological material, wherein the biological material and any packaging define a sample;
b. estimating thermal properties of the sample;
c. estimating a sensitivity of the sample to osmotic shock based on one or more biological material characteristics, the one or more biological material characteristics including at least one of: a starting frozen temperature, cell structure, cell size, membrane sensitivity, density, and age of donor;
d. performing computational fluid dynamics analysis on the sample within said tank of a thawing apparatus based on flow constraints including any one or more of: an approximated geometry of the sample; thermal properties of the sample; the apparatus geometry; predetermined arrangement of sample in the apparatus; a predetermined inlet temperature of thawing fluid; and a predetermined decrease in temperature of the thawing fluid from inlet to outlet;
e. approximating the onset of solid-liquid phase transition for the sample;
f. thawing the frozen preserved biological product for a duration up to the onset of solid-liquid transition determined at step (d).

The inlet temperature of the thawing fluid may be between about 2° C. and 100° C. inclusive, preferably about 37° C.

The onset of solid-liquid phase transition is approximated from a cooling curve of the sample undergoing freezing at a consistent cooling rate.

The thawing curve of the sample undergoing freezing is preferably obtained from said computational fluid dynamics analysis on the sample.

There is described herein an apparatus for preserving biological material, comprising an insert configured to be arranged within an outer insulated tank, the insert defining a compartment for receiving biological material, wherein inflow of a heat exchange fluid into the compartment from the outer insulated tank is at or adjacent one face of the insert, and outflow of the heat exchange fluid out of the compartment to the outer insulated tank is at or adjacent said face of the insert, the compartment comprising a wall having a series of apertures to accommodate a continuous heat exchange fluid flow through the apparatus such that, in operation, biological material in the compartment is immersed in the heat exchange fluid to exchange heat with the heat exchange fluid for freezing of said biological material, the apparatus further comprising a pump that is operable to adjust a flow of heat exchange fluid over the biological material in the compartment, the pump being operable to cool the biological material at one or more different stages of cooling.

There is further described herein a method of preserving biological material, comprising:
a. determining the total surface area of an approximated geometry of a sample of the biological material, wherein the biological material and any packaging define a sample;
b. estimating thermal properties of the sample;
c. estimating a sensitivity of the sample to osmotic shot based on one or more biological material characteristics, the one or more biological material characteristics including at least one of: cell structure, cell size, membrane sensitivity, density, and age of donor
d. performing computational fluid dynamics analysis on the sample within said compartment of the apparatus of the aspect described above based on flow constraints including any one or more of: an approximated geometry of the sample; thermal properties of the sample; the apparatus geometry; predetermined arrangement of sample in the apparatus; a predetermined inlet temperature of heat exchange fluid; a predetermined increase in temperature of the heat exchange fluid from inlet to outlet;
e. approximating the onset of liquid-solid phase transition for the sample based on the estimated sensitivity of the sample to osmotic shock;
f. determining an average temperature reduction rate of the core of the sample at a predetermined sample surface temperature up to about the onset of phase transition and corresponding heat exchange fluid flow rate required to obtain a predetermined slow cooling rate;
g. determining an average temperature reduction rate of the core of the sample at a predetermined sample surface temperature from about the onset of phase transition and corresponding heat exchange fluid flow rate required to obtain a predetermined rapid cooling rate;
h. cooling the sample in said compartment of the apparatus of the aspect described above at said slow cooling rate up to about the onset of phase transition;
i. cooling the sample in said compartment at the rapid cooling rate from about the onset of phase transition to a final target temperature.
j. storing the sample.

There is also described herein a method of determining an amount of cryoprotectant to be added to a biological material prior to preservation, comprising:
a. determining the total surface area of an approximated geometry of the biological material, including an initial amount of cryoprotectant, to be preserved, wherein the biological product, cryoprotectant and any packaging define a sample;
b. estimating thermal properties of the sample;
c. performing computational fluid dynamics analysis on the sample within said compartment of the apparatus of the aspect described above based on flow constraints including any one or more of: an approximated geometry of the sample; thermal properties of the sample; the apparatus geometry; predetermined arrangement of sample in the apparatus; a predetermined inlet temperature of heat exchange fluid; and a predetermined increase in temperature of the heat exchange fluid from inlet to outlet;
d. estimating a sensitivity of the sample to osmotic shock based on one or more biological material characteristics, the one or more biological material characteristics including at least one of: cell structure, cell size, membrane sensitivity, density, and age of donor;
e. approximating the onset of liquid-solid phase transition for the sample based on the estimated sensitivity of the sample to osmotic shock;
f. determining an average temperature reduction rate of the core of the sample at a predetermined sample surface temperature up to about the onset of phase transition and corresponding heat exchange fluid flow rate required to obtain a predetermined slow cooling rate;
g. determining an average temperature reduction rate of the core of the sample at a predetermined sample surface temperature from about the onset of phase transition and corresponding heat exchange fluid flow rate required to obtain a predetermined rapid cooling rate; and
h. if the heat exchange fluid flow rate calculated at step (f) corresponds to a pump duty or an evaporator duty of the apparatus that is above a predetermined pump duty or predetermined evaporator duty respectively, selecting an amount of cryoprotectant that is a predetermined amount more than the initial amount to define a new initial amount or, if the heat exchange fluid flow rate calculated at step (f) corresponds to a pump duty or an evaporator duty that is equal to or less than the predetermined pump duty or predetermined evaporator duty respectively, selecting the initial amount of cryoprotectant as said amount of cryoprotectant to be added to a biological material prior to preservation; and
i. if the heat exchange fluid flow rate calculated at step (f) corresponds to a pump duty or an evaporator duty that is above the predetermined pump duty or predetermined evaporator duty respectively, repeating steps (a) to (g) until the heat exchange fluid flow rate calculated at step (f) corresponds to a pump duty or an evaporator duty that is equal to or less than the predetermined pump duty or predetermined evaporator duty respectively

There is further described herein an apparatus for thawing frozen preserved biological material comprising a thawing tank for receiving biological material, said biological material being held within the tank in a structure comprising one or more of a tray, a rack and a basket, a tank inlet via which thawing fluid is introduced into the tank, and a tank outlet via which thawing fluid is removed from the tank, wherein the tank is configured to accommodate a continuous thawing fluid flow through the apparatus such that, in operation, biological material in the tank is immersed in the thawing fluid to exchange heat with the thawing fluid for thawing of said biological material.

There is also described herein a method of thawing a frozen preserved biological material, comprising:
a. determining the total surface area of an approximated geometry of the biological material, wherein the biological material and any packaging define a sample;
b. estimating thermal properties of the sample;
c. estimating a sensitivity of the sample to osmotic shock based on one or more biological material characteristics, the one or more biological material characteristics including at least one of: a starting frozen temperature, cell structure, cell size, membrane sensitivity, density, and age of donor;
d. performing computational fluid dynamics analysis on the sample within said tank of a thawing apparatus of the aspect described above based on flow constraints including any one or more of: an approximated geometry of the sample; thermal properties of the sample; the apparatus geometry;
predetermined arrangement of sample in the apparatus; a predetermined inlet temperature of thawing fluid; and a predetermined decrease in temperature of the thawing fluid from inlet to outlet;
e. approximating the onset of solid-liquid phase transition for the sample;
f. thawing the frozen preserved biological product for a duration up to the onset of solid-liquid transition determined at step (d).

### BRIEF DESCRIPTION

Embodiments of the present invention will now be described, by way of non-limiting example only, with reference to the accompanying drawings, in which:

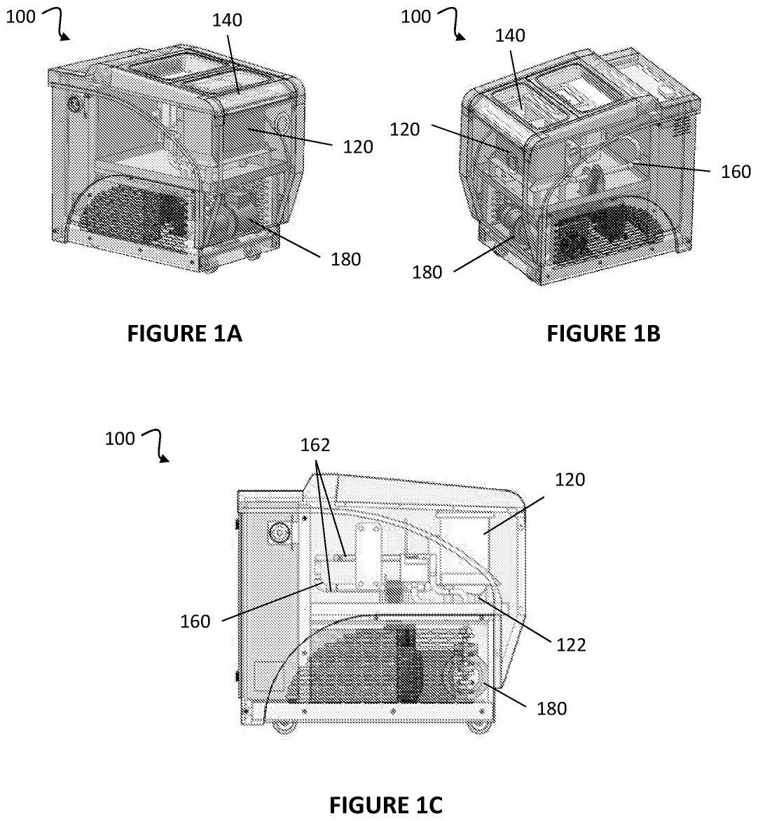

FIGS. 1A to 1C are different views of an apparatus for preserving biological material according to one embodiment;

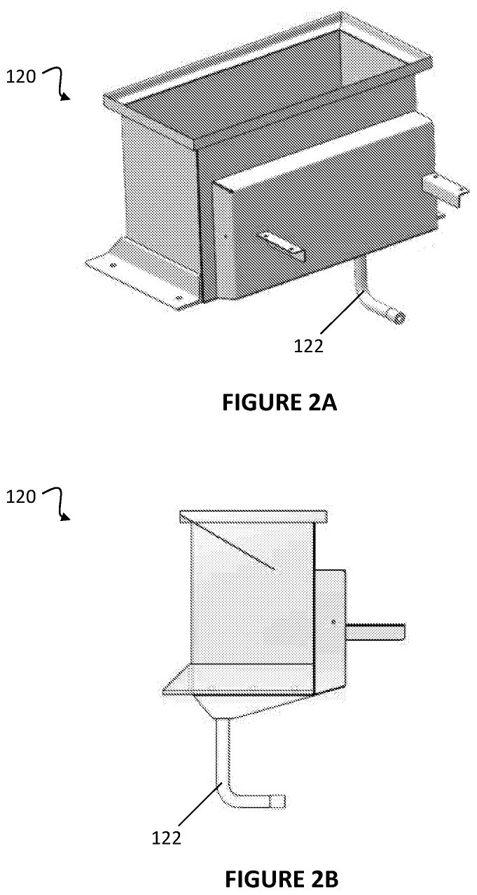

FIGS. 2A and 2B are perspective and side views respectively of a tank for the apparatus of FIG. 1 according to one embodiment;

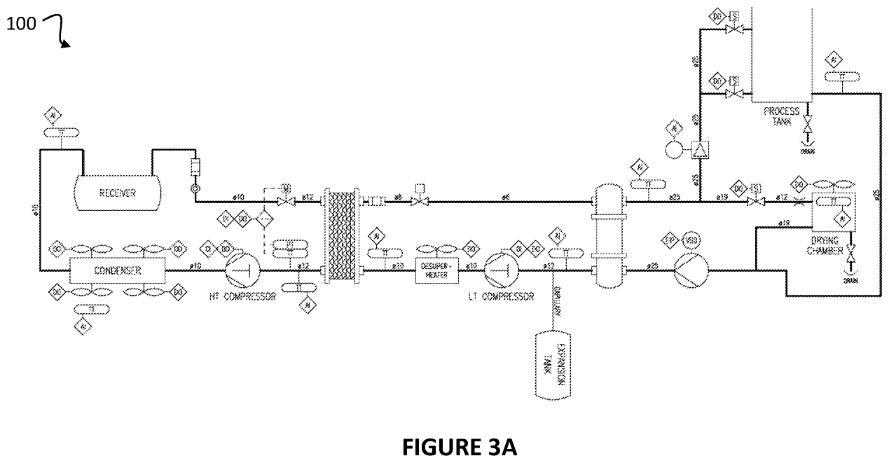

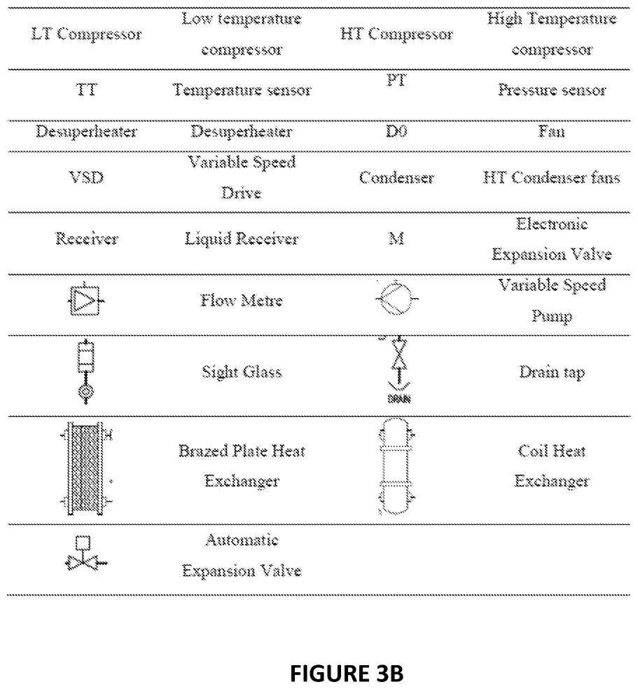

FIG. 3A is a piping and instrumentation diagram of the apparatus according to one embodiment;

FIG. 3B is a PID legend for components in the diagram of FIG. 3A;

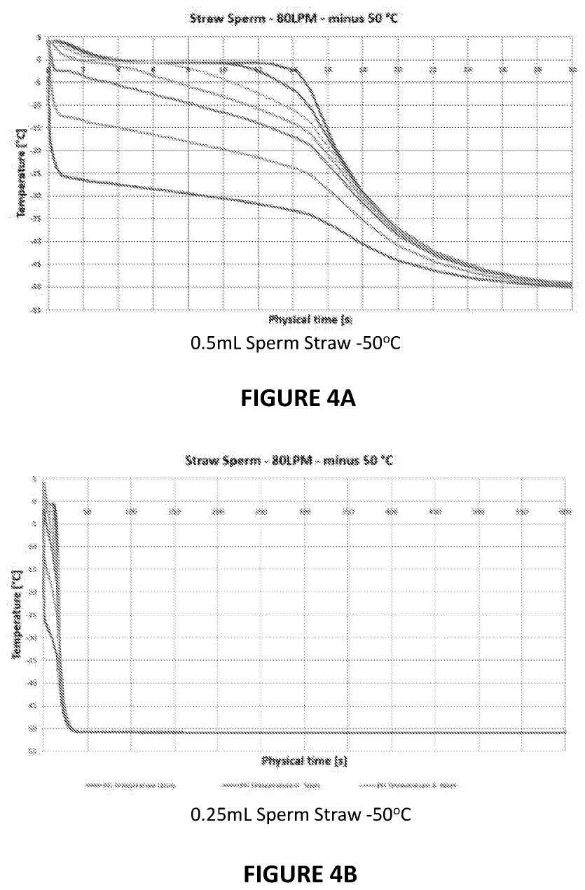

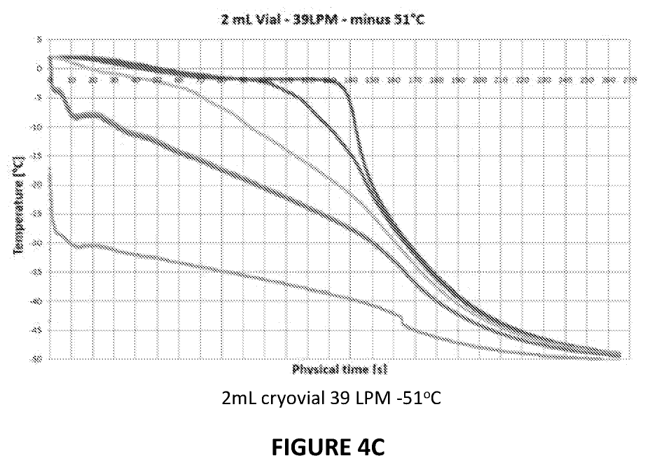

FIG. 4A is a temperature-time plot of the central cryovial in the tank according to one embodiment, frozen to about −80° C. within about 65 seconds;

FIG. 4B is a temperature-time plot of the central cryovial in the tank according to one embodiment, frozen to about −51° C. within about 80 seconds; and

FIG. 4C is a temperature-time plot of the central cryovial in the tank according to one embodiment, frozen at the same rate as the simulation of FIG. 4A, but with the baffle removed from the insert.

### DETAILED DESCRIPTION

Details of the apparatus and method of the specification of international application no. PCT/AU2019/051279 (published as WO 2020/102854 on 28 May 2020), in the name of Cryogenics Holdings Pty Ltd, are incorporated herein by way of reference.

FIGS. 1 to 3 illustrate an apparatus 100 for preserving biological material according to one embodiment, comprising an insulated tank (or an immersion tank) 120 that is configured to receive an insert 140. The insert 140 defines a compartment for receiving biological material, wherein inflow, through inlets, of a heat exchange fluid into the compartment from the outer insulated tank 120 is at or adjacent one face of the insert 140, and outflow, through outlets, of the heat exchange fluid out of the compartment to the outer insulated tank is at or adjacent said face of the insert 140.

The apparatus includes a pump 180 that is operable to adjust a flow of heat transfer fluid over the biological material in the compartment. In particular, the pump is operable to cool the biological material at one or more different stages of cooling. The one or more different stages may be based on a heat transfer response of the biological material. The heat transfer response is based on thermodynamic modelling of the biological material. The pump 180 has a pumping capacity of at least 50 L/min. In other examples, the pump has a pumping capacity of at least 60 L/min, preferably at least 70 L/min, and further preferably at least about 80 L/min. Additionally or alternatively, the pump may have a pumping capacity of more than 50 L/min. Further additionally or alternatively, the pump may have a pumping capacity of up to about 100 L/min, or up to 120 L/min, or up to about 150 L/min. The apparatus has a high temperature compressor that allows for faster temperature pull down time for the biological material, and allows for more temperature and flow consistency through the compartment.

The apparatus 100 comprises a tube arrangement 160 for conveying the heat transfer fluid from the pump 180 to the insert 140. A flow meter is coupled to the tube arrangement for monitoring the flow of heat transfer fluid through the tube arrangement. The flow meter provides feedback to the pump for controlling the flow of heat transfer fluid through the tube arrangement and into the compartment. A flow conditioner is provided to the tube arrangement for evenly distributing the heat transfer fluid before delivery to the insert. The tube arrangement 160 has two spaced apart, and parallel, substantially linear elongate inlet tube portions (or substantially straight inlet tube sections) 162 leading into the insert 140. The inlet tube portions each have a length of at least about 0.2 m. In other examples, the inlet tube portions may have a length of at least about 0.4 m, or at least about 0.5 m. The linear elongate tubes are arranged immediately before the compartment. In this way, the heat transfer fluid can enter the compartment with substantially no turbulent flow or substantially without any pressure head. In particular, the present design minimises the bends in the tube arrangement from the pump to the compartment in order to provide a smooth and uninterrupted flow of heat transfer fluid to the compartment. The tube portion of the tube arrangement 160 has a diameter of about 1 inch. In other examples, the tube portion of the tube arrangement has a diameter of about 0.5 inches or up to about 1.5 inches.

The insert 140 comprises a wall having a series of apertures to accommodate a continuous heat exchange fluid flow through the apparatus such that, in operation, biological material in the compartment is immersed in the heat exchange fluid to exchange heat with the heat exchange fluid for freezing of said biological material. Each of the apertures has a diameter or width of between about 5 mm and 20 mm, preferably about 10 mm.

The insert 140 comprises a baffle configured to direct flow of the heat exchange fluid through the compartment along one or more specific pathways. In the illustrated embodiment, flow of the heat exchange fluid is directed from the inlets adjacent the front side of the insert, through the compartment and out of intermediate outlets, then back to the front side of the insert and out of outlets. The specific flow path directed by baffle improves circulation of heat exchange fluid through the compartment and reduces hot spots. Further, the specific configuration of inflow and outflow of heat exchange fluid at or adjacent a common face of the insert 140 forces the fluid to circulate through the entire compartment, with the fluid rebounding off the opposite face of the insert 140 to improve circulation.

The compartment is configured to receive a structure for holding the biological material, the structure being one or more of a tray, a rack and a basket. The compartment comprises a plurality of internal dividers defining a plurality of sub-compartments, each sub-compartment configured to receive one of said structures.

When the insert 140 is arranged within the tank 120, one side of the tank 120, adjacent the face of the insert 140, comprises at least one inlet and at least one outlet. The tank according to a preferred embodiment of the present invention has two inlets and one outlet. The inlet communicates from an outside of the outer insulated tank 120 into the compartment in use, and the outlet communicates from the compartment to an outside of the outer insulated tank in use (via drain pipe 142), such that in operation, the heat exchange fluid is introduced into the tank 120 (and thereby into the compartment) via said at least one inlet and removed from the compartment and tank 120 via said at least one outlet.

The side wall of the tank 120 is spaced from the face of the insert 140, thus defining a void (not shown). The tank 120 is preferably constructed of steel to conform with ASTM A240.

In use, the tank 120 is filled with heat exchange fluid which does not freeze above −80° C. The heat exchange fluid is pumped into the tank 120 via the tube arrangement 160 and the heat exchange fluid inlet of the tank 120 into the void at a predetermined volumetric flow rate. Pressure is built up in the void as heat exchange fluid is forced through the restricted areas of the apertures, thus reducing the volumetric flow rate but increasing velocity of the fluid entering the compartment. The apertures and baffle provide improved distribution of cold fluid to all parts of the compartment and minimise the occurrence of hot spots which would otherwise be likely to occur away from the inlet area. As the heat transfer fluid flows continuously through the tank 120 and compartment, heat is removed from the biological materials located within the compartment, and the heated heat exchange fluid leaving the compartment and tank 120 will then be exchanged with a refrigeration system of the apparatus which continuously cools the heat exchange fluid. The heat exchange fluid itself exchanges heat with refrigerant in the refrigeration system.

FIG. 3A is a piping and instrumentation diagram of a refrigeration system of the apparatus 100 according to one embodiment that continuously cools the heat exchange fluid. The refrigeration system includes a heat exchanger for exchanging heat between the heat transfer fluid and the refrigerant. The heat exchanger includes a brazed plate heat exchanger and a coil heat exchanger. The refrigeration system includes the components outlined in the PID legend in FIG. 3B.

### Two-Phase Cooling Preservation Method

The inventors have found that by increasing the rate of cooling at a specific stage of freezing, the biological product can be preserved with a reduced level of cryoprotectant, and in some cases, even without the use of cryoprotectant. Specifically, the present preservation method implements two-phase cooling, with slow cooling up to about the onset of liquid-solid phase transition, then rapid cooling from about the onset of liquid-solid phase transition. Nucleation begins at the onset of phase transition and continues into the solid freezing phase. The inventors have found that reducing the duration of nucleation to thereby reduce ice crystal formation in the sample produces a fast freezing effect similar to liquid nitrogen freezing but with reduced osmotic damage compared to conventional liquid nitrogen methods. Specifically, the present method involves increasing the cooling rate (ie initiating rapid freezing of the sample) from about the onset of liquid-solid phase transition to reduce the duration of nucleation of the biological material. In some cases, the reduction in freezing damage is so significant that no cryoprotectant is necessary.

In one embodiment, a method of preserving a biological material comprises first determining the total surface area of an approximated geometry of the biological material, wherein the biological material and any packaging define a sample, estimating the thermal properties of the sample including estimating a sensitivity of the biological material to osmotic shock based on one or more biological material characteristics (which includes cell structure, cell size, membrane sensitivity, density, and age of donor) and performing computational fluid dynamics analysis on the sample via simulation of the sample being frozen within the apparatus 2 (more specifically, within the compartment 6) to investigate the influence of varying input parameters of the preservation system. Inputs/constraints of the simulation that may be investigated include the characteristics of the packaging and the characteristics of the racking systems utilised, an approximated geometry of the sample, thermal properties of the sample, the apparatus geometry, the predetermined arrangement of sample in the apparatus, a predetermined inlet temperature of heat exchange fluid, and a predetermined increase in temperature of the heat exchange fluid from inlet to outlet.

The computational fluid dynamic analysis according to one embodiment involves dividing the biological material into geometrical increments (e.g. cylindrical shells for bottles or test tubes). For every one of these increments, a conservation of energy equation is solved, i.e. for a given time-step, a certain amount of energy is removed from a shell, resulting in a decrease in temperature of that shell. The amount of energy removed is a function of the temperatures of the adjacent shells, as well as the resistance to heat flow between the shells. This involves taking into account thermal properties of the biological material as a function of temperature.

Analysis is performed assuming that the sample may be treated as a solid mass having a starting temperature of 2° C., and having thermal properties which can be identified, estimated or calculated using methods that will be known to the person skilled in the art.

On the basis of the total surface area of the product, load volume of the product in the tank, a pre-selected inlet temperature of heat exchange fluid, a pre-selected acceptable outlet temperature of heat exchange fluid (e.g. 3° C. greater than the inlet temperature), the thermal properties of the product (including cryoprotectant) and packaging and pre-selected velocity of fluid through the tank, etc, the rate of temperature reduction of product can be simulated as detailed above. The temperature-time plots in FIGS. 4A and 4B correspond to the analysis on a central 0.5 ml cryovial, which is centrally located in the compartment, frozen to about −80° C. within about 65 seconds and to about −51° C. within about 80 seconds respectively. From these two figures, according to preferred embodiments of the invention, the cryovials frozen to about −51° C. achieves better preservation results compared to cryovials frozen to about −80° C. The graph plots the temperature at various shells through the cryovials, from the outside (“PG Temperature 2.99 mm PPoutside”) to the core (“PG Temperature 0 mm”). FIG. 4C is a temperature-time plot of the central cryovial, frozen at the same rate as the simulation of FIG. 8, but with the baffle removed from the insert, illustrating the effectiveness of the baffle at improving circulation of heat transfer fluid through the compartment.

The onset of liquid-solid phase transition for the sample is approximated. In one embodiment, the onset of liquid-solid phase transition is approximated from the cooling curve obtained from one or more test results of samples of the material undergoing freezing at a consistent cooling rate and based on the estimated sensitivity of the biological material to osmotic shock. Onset of liquid-solid phase transition may additionally or alternatively be determined/confirmed from the cooling curve of the sample obtained via the computational fluid dynamics analysis described above.

For a predetermined slow cooling rate, the average temperature reduction rate of the core of the sample at a predetermined sample surface temperature up to about the onset of phase transition is determined (from the computational fluid dynamics model). The heat exchange fluid flow rate into immersion tank required to achieve the slow cooling rate may then be determined.

The heat exchange fluid flow rate required for achieving a predetermined rapid cooling rate is similarly determined via analysis of the average temperature reduction rate of the core of the sample at a predetermined sample surface temperature from about the onset of phase transition.

Once the analysis is complete, the sample may then be cooled in the compartment of the apparatus 100 as described above, first at the slow cooling rate up to about the onset of phase transition, then at the rapid cooling rate from about the onset of phase transition. The sample is cooled at at least about 100° C. per minute until a predetermined end temperature is achieved.

To achieve the required heat exchange fluid flow rate for rapid cooling, the pump duty of the pump of the apparatus 100 which inputs the heat exchange fluid into the tank 120 is increased.

It is envisaged that in some embodiments, the method described above may be used to effectively preserve biological material without the use of any cryoprotectant.

### Method of Determining Amount of Cryoprotectant Required for Preservation Process

In some cases, cryoprotectant may be required to minimise cell damage during the preservation process. Accordingly, in another aspect, there is provided a method of determining the amount of cryoprotectant to be added to a biological material prior to preservation. The method comprises first determining the total surface area of an approximated geometry of the biological material, including an initial amount of cryoprotectant, to be preserved, wherein the biological material, cryoprotectant and any packaging define a sample, estimating thermal the properties of the sample and performing computational fluid dynamics analysis on the sample within the apparatus (more specifically, within the compartment 6) to investigate the influence of varying input parameters of the preservation system. Inputs/constraints of the simulation that may be investigated include the characteristics of the packaging and the characteristics of the racking systems utilised, an approximated geometry of the sample, thermal properties of the sample, the apparatus geometry, the predetermined arrangement of sample in the apparatus, a predetermined inlet temperature of heat exchange fluid, and a predetermined increase in temperature of the heat exchange fluid from inlet to outlet.

The method further comprises estimating a sensitivity of the sample to osmotic shock based on one or more biological material characteristics, the one or more biological material characteristics including at least one of: cell structure, cell size, membrane sensitivity, density, and age of donor.

The onset of liquid-solid phase transition for the sample is approximated. In one embodiment, the onset of liquid-solid phase transition is approximated from the cooling curve obtained from one or more test results of samples of the material undergoing freezing at a consistent cooling rate. Onset of liquid-solid phase transition may additionally or alternatively be determined/confirmed from the cooling curve of the sample obtained via the computational fluid dynamics analysis described above. In a preferred embodiment, the onset is approximated based on the estimated sensitivity of the biological material to osmotic shock.

For a predetermined slow cooling rate, the average temperature reduction rate of the core of the sample at a predetermined sample surface temperature up to about the onset of phase transition is determined (from the computational fluid dynamics model described above). The heat exchange fluid flow rate into immersion tank 2 required to achieve the slow cooling rate may then be determined.

The heat exchange fluid flow rate required for achieving a predetermined rapid cooling rate is similarly determined via analysis of the average temperature reduction rate of the core of the sample at a predetermined sample surface temperature from about the onset of phase transition. If the heat exchange fluid flow rate calculated at this step corresponds to a pump duty or an evaporator duty of the apparatus that is above a predetermined pump duty or predetermined evaporator duty respectively, an amount of cryoprotectant that is a predetermined amount more than the initial amount is selected to define a new initial amount. If, on the other hand, the heat exchange fluid flow rate calculated at this step corresponds to a pump duty or an evaporator duty that is equal to or less than the predetermined pump duty or predetermined evaporator duty respectively (ie the heat exchange fluid flow rate is acceptable from a practical standpoint, e.g. if the pump duty is acceptable based on the viscosity of heat exchange fluid at the selected temperature or if the evaporator duty is acceptable based on the required heat removal), that initial amount of cryoprotectant is selected as the amount of cryoprotectant to be added to the biological material prior to preservation.

If the heat exchange fluid flow rate calculated corresponds to a pump duty or an evaporator duty that is above the predetermined pump duty or predetermined evaporator duty respectively, the method steps are repeated until the heat exchange fluid flow rate calculated corresponds to a pump duty or an evaporator duty that is equal to or less than the predetermined pump duty or predetermined evaporator duty respectively.

In one embodiment, the initial amount of cryoprotectant is zero. If the calculation steps are to be repeated, the predetermined amount of cryoprotectant more than the initial amount may be increased in regular increments, such as 1% more in each repetition.

Once the appropriate amount of cryoprotectant is determined using the method above, samples of the biological material may then be prepared with the calculated amount of cryoprotectant for preserving using the apparatus 10 as described above.

The predetermined slow and/or rapid cooling rates may be identified based on conventional protocols or based on trials or analyses conducted on specific samples of biological materials. In one embodiment, the slow cooling rate is up to about 10° C. per minute. The slow cooling rate may be between about 0.1° C. and about 10° C. per minute.

In one embodiment, the rapid cooling rate is greater than about 100° C. per minute. The rapid cooling rate may be greater than about 200° C. per minute.

### Method of Determining Biological Products Osmotic Shock Sensitivity

Osmotic shock or osmotic stress is physiologic dysfunction caused by a sudden change in the solute concentration around a cell, which causes a rapid change in the movement of water across its cell membrane. Under conditions of high concentrations of either salts, substrates or any solute in the supernatant, water is drawn out of the cells through osmosis. This also inhibits the transport of substrates and cofactors into the cell thus “shocking” the cell. Alternatively, at low concentrations of solutes, water enters the cell in large amounts, causing it to swell and either burst or undergo apoptosis.

All organisms have mechanisms to respond to osmotic shock, with sensors and signal transduction networks providing information to the cell about the osmolarity of its surroundings; these signals activate responses to deal with extreme conditions. Although single-celled organisms are more vulnerable to osmotic shock, since they are directly exposed to their environment, cells in mammals still suffer these stresses under some conditions.

All organisms have difference cellular structures. Parameters including cell size, membrane sensitivity, age of organism and density of the cell influence the organism's sensitivity to osmotic stress.

A person skilled in the field will understand the above parameters. All organisms can be plotted on a sensitivity scale based on the analysis described above.

Preservation parameters including temperature and cryoprotectant can be influenced by an organism's osmotic sensitivity. The analysis described above will inform pump duty and processing temperature parameters.

High osmotic sensitivity requires an increased processing temperature of above −50 c.

Low osmotic sensitivity requires a decreased processing temperature of at or below −50 c.

High osmotic sensitivity requires an increased pump duty to achieve the same heat transfer rates to lower temperature comparisons

### Thawing Apparatus and Methods

In one embodiment, a method of thawing a frozen preserved biological material, comprises first determining the total surface area of an approximated geometry of the biological material, wherein the biological material and any packaging define a sample, estimating thermal properties of the sample and performing computational fluid dynamics analysis on the sample via simulation of the sample being thawed within the thawing tank to investigate the influence of varying input parameters of the thawing system. Inputs/constraints of the simulation that may be investigated include the characteristics of the packaging and the characteristics of the racking systems utilised, an approximated geometry of the sample; thermal properties of the sample; the apparatus geometry; predetermined arrangement of sample in the apparatus; a predetermined inlet temperature of thawing fluid; and a predetermined decrease in temperature of the thawing fluid from inlet to outlet.

The method further comprises estimating a sensitivity of the sample to osmotic shock based on one or more biological material characteristics, the one or more biological material characteristics including at least one of: a starting frozen temperature, cell structure, cell size, membrane sensitivity, density, and age of donor.

The onset of solid-liquid phase transition for the sample is approximated. In one embodiment, the onset of solid-liquid phase transition is approximated from the cooling curve obtained from one or more test results of samples of the material undergoing freezing at a consistent cooling rate. Onset of solid-liquid phase transition may additionally or alternatively be determined/confirmed from the thawing curve of the sample obtained via the computational fluid dynamics analysis described above. In a preferred embodiment, the onset of solid-liquid phase transition is approximated based on the estimated sensitivity of the sample to osmotic shock.

The sample is then thawed for a duration up to the onset of solid-liquid transition. It has been found that thawing frozen samples up to the onset of transition increases cell viability. After thawing, the sample is maintained at a temperature of about 2° C.

In some embodiments, the thawing fluid is water input at a temperature of 37° C.

While various embodiments of the present invention have been described above, it should be understood that they have been presented by way of example only, and not by way of limitation. It will be apparent to a person skilled in the relevant art that various changes in form and detail can be made therein without departing from the spirit and scope of the invention. Thus, the present invention should not be limited by any of the above described exemplary embodiments.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of Endeavor to which this specification relates.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

1. An apparatus for preserving biological material, comprising
an insert configured to be arranged within an outer insulated tank, the insert defining a compartment for receiving biological material, such that, in operation, biological material in the compartment is immersed in the heat exchange fluid to exchange heat with the heat exchange fluid for freezing of said biological material,
the apparatus further comprising a pump that is operable to adjust a flow of heat exchange fluid over the biological material in the compartment, the pump being operable to cool the biological material at one or more different stages of cooling.

2. The apparatus of claim 1, wherein the pump has a pumping capacity of at least 50 L/min, at least 60 L/min, at least 70 L/min, at least about 80 L/min, and/or preferably up to about 100 L/min, preferably up to 120 L/min, preferably up to about 150 L/min.

3. The apparatus of claim 1, further including a tube arrangement for conveying the heat transfer fluid from the pump to the compartment, the tube arrangement including a substantially linear elongate tube portion leading into the compartment, and having a length of at least about 0.2 m, preferably at least about 0.4 m, and further preferably at least about 0.5 m.

4. The apparatus of claim 3, wherein the elongate tube portion has a diameter of about 1 inch, about 0.5 inches, or up to about 1.5 inches.

5. The apparatus of claim 1, wherein inflow of a heat exchange fluid into the compartment from the outer insulated tank is at or adjacent one face of the insert, and outflow of the heat exchange fluid out of the compartment to the outer insulated tank is at or adjacent said face of the insert.

6. The apparatus of claim 1, wherein the insert comprises a baffle configured to direct flow of the heat exchange fluid through the compartment along one or more specific pathways.

7. The apparatus of claim 1, including a structure receivable in the compartment for holding the biological material, wherein the structure is one or more of a tray, a rack and a basket.

8. The apparatus of claim 7, wherein the compartment comprises a plurality of internal dividers defining a plurality of sub-compartments, each sub-compartment configured to receive one of said structures.

9. The apparatus of claim 1, wherein the outer insulated tank comprises:
one side adjacent said face of the insert when the insert is arranged within the outer insulated tank, said side comprising at least one inlet and at least one outlet, the inlet communicating from an outside of the outer insulated tank into the compartment in use, and the outlet communicating from the compartment to an outside of the outer insulated tank in use,
wherein, in operation, said heat exchange fluid is introduced into the tank via said at least one inlet and removed from the tank via said at least one outlet.

10. A method of preserving biological material, comprising:
a. estimating a sensitivity of the sample to osmotic shock based on one or more biological material characteristics, the one or more biological material characteristics including at least one of: cell structure, cell size, membrane sensitivity, density, and age of donor;
b. approximating the onset of liquid-solid phase transition for the sample based on the estimated sensitivity of the same to osmotic shock;
c. determining an average temperature reduction rate of the core of the sample at a predetermined sample surface temperature up to about the onset of phase transition and corresponding heat exchange fluid flow rate required to obtain a predetermined slow cooling rate;
d. determining an average temperature reduction rate of the core of the sample at a predetermined sample surface temperature from about the onset of phase transition and corresponding heat exchange fluid flow rate required to obtain a predetermined rapid cooling rate;
e. cooling the sample in said compartment of the apparatus of any one of claims 1 to 9 at said slow cooling rate up to about the onset of phase transition; and
f. cooling the sample in said compartment at the rapid cooling rate from about the onset of phase transition to a final target temperature.

11. The method of claim 10, further comprising immediately storing the cooled sample from the compartment.

12. The method of claim 10, wherein the sample does not contain cryoprotectant.

13. A method of determining an amount of cryoprotectant to be added to a biological material prior to preservation, comprising:
a. estimating a sensitivity of the sample to osmotic shock based on one or more biological material characteristics, the one or more biological material characteristics including at least one of: cell structure, cell size, membrane sensitivity, density, and age of donor;
b. approximating the onset of liquid-solid phase transition for the sample based on the estimated sensitivity of the sample to osmotic shock;
c. determining an average temperature reduction rate of the core of the sample at a predetermined sample surface temperature up to about the onset of phase transition and corresponding heat exchange fluid flow rate required to obtain a predetermined slow cooling rate;
d. determining an average temperature reduction rate of the core of the sample at a predetermined sample surface temperature from about the onset of phase transition and corresponding heat exchange fluid flow rate required to obtain a predetermined rapid cooling rate; and
e. if the heat exchange fluid flow rate calculated at step (c) corresponds to a pump duty or an evaporator duty of the apparatus that is above a predetermined pump duty or predetermined evaporator duty respectively, selecting an amount of cryoprotectant that is a predetermined amount more than the initial amount to define a new initial amount or, if the heat exchange fluid flow rate calculated at step (c) corresponds to a pump duty or an evaporator duty that is equal to or less than the predetermined pump duty or predetermined evaporator duty respectively, selecting the initial amount of cryoprotectant as said amount of cryoprotectant to be added to a biological material prior to preservation; and
f. if the heat exchange fluid flow rate calculated at step (c) corresponds to a pump duty or an evaporator duty that is above the predetermined pump duty or predetermined evaporator duty respectively, repeating steps (a) to (d) until the heat exchange fluid flow rate calculated at step (c) corresponds to a pump duty or an evaporator duty that is equal to or less than the predetermined pump duty or predetermined evaporator duty respectively.

14. The method of claim 13, wherein the initial amount of cryoprotectant prior to any repetition of steps (a) to (d) is zero.

15. The method of claim 10, wherein the slow cooling rate is one of:
a. up to about 10° C. per minute; and
b. between about 0.1° C. and about 10° C. per minute.

16. (canceled)

17. The method of claim 10, wherein the rapid cooling rate is one of:
a. greater than about 100° C. per minute; and
b. greater than about 200° C. per minute.

18. (canceled)

19. The method of claim 10, wherein at least one of:
a. the onset of liquid-solid phase transition is approximated from a cooling curve of the sample undergoing freezing at a consistent cooling rate; and
b. the cooling curve of the sample undergoing freezing is obtained from said computational fluid dynamics analysis on the sample.

20. (canceled)

21. A method of thawing a frozen preserved biological material, comprising:
a. determining the total surface area of an approximated geometry of the biological material, wherein the biological material and any packaging define a sample;
b. estimating thermal properties of the sample;
c. estimating a sensitivity of the sample to osmotic shock based on one or more biological material characteristics, the one or more biological material characteristics including at least one of: a starting frozen temperature, cell structure, cell size, membrane sensitivity, density, and age of donor;
d. performing computational fluid dynamics analysis on the sample within said tank of a thawing apparatus based on flow constraints including any one or more of: an approximated geometry of the sample; thermal properties of the sample; the apparatus geometry; predetermined arrangement of sample in the apparatus; a predetermined inlet temperature of thawing fluid; and a predetermined decrease in temperature of the thawing fluid from inlet to outlet;
e. approximating the onset of solid-liquid phase transition for the sample;
f. thawing the frozen preserved biological product for a duration up to the onset of solid-liquid transition determined at step (d).

22. The method of claim 21, wherein the inlet temperature of the thawing fluid between about 2° C. and 100° C. inclusive, preferably about 37° C.

23. The method of claim 21, wherein at least one of:
a. the onset of solid-liquid phase transition is approximated from a cooling curve of the sample undergoing freezing at a consistent cooling rate; and
b. the thawing curve of the sample undergoing freezing is obtained from said computational fluid dynamics analysis on the sample.

24. (canceled)
